(19) United States
(12) Patent Application Publication
(10) Pub. No.: US 2021/0090573 A1
(43) Pub. Date: Mar. 25, 2021

(54) CONTROLLING A USER INTERFACE

(71) Applicant: Audio Analytic Ltd, Cambridgeshire (GB)

(72) Inventors: Christopher James Mitchell, Cambridgeshire (GB); Sacha Krstulovic, Cambridgeshire (GB); Joe Patrick Lynas, Cambridgeshire (GB); Julian Harris, Cambridgeshire (GB)

(21) Appl. No.: 16/580,959

(22) Filed: Sep. 24, 2019

(51) Int. Cl. G10L 15/30; G10L 15/22; G06F 3/0484; G10L 25/51

(52) U.S. Cl. CPC G10L 15/30; G10L 15/22; H04R 29/004; G10L 25/51; G10L 2015/223; G06F 3/0484

(57) ABSTRACT

A computing device for controlling a user interface of the computing device, the computing device comprising a processor configured to: detect at least one target sound in a monitored environment; determine an operating mode of the computing device that is associated with the at least one target sound; output content, via the user interface of the computing device, that is associated with the operating mode, wherein the content prompts a user of the computing device to perform an action using an input device of the computing device to instruct the computing device to control a controllable device in the monitored environment in response to the recognition of the at least one target sound.

Background information on sound recognition systems and methods can be found in the applicant's PCT application WO2010/070314, which is hereby incorporated by reference in its entirety.

### FIELD OF THE INVENTION

The invention generally relates to controlling a user interface of the computing device, and to related systems, methods and computer program code.

### BACKGROUND TO THE INVENTION

The present applicant has recognised the potential for new applications of sound recognition systems.

### SUMMARY OF THE INVENTION

The inventors have identified that configuring a smart device experience is a complex and time consuming process for a user which typically involves a user creating routines in advance in order to get the most from their smart device experience (e.g. if X is detected by sensor Y do Z).

Embodiments of the present disclosure provide dynamic intelligent adaptation of a user interface to provide context-appropriate support in the moment.

According to one aspect of the present disclosure there is provided a computing device for controlling a user interface of the computing device, the computing device comprising a processor configured to: recognise at least one target sound in a monitored environment; determine an operating mode of the computing device that is associated with the at least one target sound; output content, via the user interface of the computing device, that is associated with the operating mode, wherein the content prompts a user of the computing device to perform an action using an input device of the computing device to instruct the computing device to control a controllable device in the monitored environment in response to the recognition of the at least one target sound.

Thus, in embodiments of the present disclosure sound recognition is used to inform context-appropriate personalisation to a user interface (e.g. displayed UI elements look and feel, sound or synthetic speech playback, presented information etc.) thus improving the user experience by simplifying the configuration and operation of a controllable device.

The user interface may be a speaker coupled to said processor and the input device is a microphone of the computing device, and the content is an audio message

The processor may be configured to: receive via the microphone an instruction from the user to control the controllable device; and control the controllable device in response to receiving said instruction.

The user interface may be a display coupled to said processor and the content comprises at least one user selectable element.

The processor may be configured to: detect selection of the at least one user selectable element; and control the controllable device in response to said selection.

The at least one target sound may be a non-verbal sound.

The at least one target sound comprises one of a breaking glass sound, a smoke alarm sound, and a baby cry sound.

The content may prompt a user of the computing device to perform an action using an input device of the computing device to instruct the computing device to control a remote alarm device in the monitored environment to output an audible alarm.

The content may prompt a user of the computing device to perform an action using an input device of the computing device to instruct the computing device to control a lighting unit in the monitored environment.

The content may prompt a user of the computing device to perform an action using an input device of the computing device to instruct the computing device to control a door lock of a door in the monitored environment.

The content may prompt a user of the computing device to perform an action using an input device of the computing device to instruct the computing device to control a speaker in the monitored environment to play audio.

The processor may be coupled to a microphone and the processor may be configured to: receive, via the microphone, an audio signal of audio in the monitored environment; and process the audio signal to recognise the at least one target sound.

The computing device may comprise a communications interface and the processor may be configured to: receive, via said communications interface, a message from a remote computing device in the monitored environment; and recognise the at least one target sound based on receipt of said message.

The content may additionally prompt a user of the computing device to perform an action using an input device of the computing device to initiate a call to a remote computing device in response to the recognition of the at least one target sound.

According to another aspect of the present disclosure there is provided a method of controlling a user interface of a computing device, the method comprising: recognising at least one target sound in a monitored environment; determining an operating mode of the computing device that is associated with the at least one target sound; outputting content, via the user interface of the computing device, that is associated with the operating mode, wherein the content prompts a user of the computing device to perform an action using an input device of the computing device to instruct the computing device to control a controllable device in the monitored environment in response to the recognition of the at least one target sound.

According to another aspect of the present disclosure there is provided a computer-readable storage medium comprising instructions which, when executed by a processor of a computing device cause the computing device to: recognise at least one target sound in a monitored environment; determine an operating mode of the computing device that is associated with the at least one target sound; output content, via the user interface of the computing device, that is associated with the operating mode, wherein the content prompts a user of the computing device to perform an action using an input device of the computing device to instruct the computing device to control a controllable device in the monitored environment in response to the recognition of the at least one target sound.

The inventors have also recognised that in certain situations it is difficult for a user to interact with display elements displayed on the display of their device (e.g., when a user is walking or driving a vehicle). This causes the user to make incorrect or unintentional selections in the user interface displayed on the display of the computing device and the processor on the computing device must incur unnecessary processor resource processing these inputs.

According to another aspect of the present disclosure there is provided a computing device for controlling a display of the computing device, the computing device comprising a processor coupled to a microphone, wherein the processor is configured to: output at least one display element on a display of the computing device; whilst the at least one display element is being displayed on the display, recognise at least one target sound in a monitored environment; determine an operating mode of the computing device that is associated with the at least one target sound; and modify the output of the at least one display element on the display based on the operating mode.

The at least one display element may comprise text and the processor is configured to modify the output of the text by modifying a font size of the text.

The at least one display element may comprise a user selectable element, and the processor is configured to modify the output of the user selectable element by modifying a size of the user selectable element.

The at least one display element may comprise a plurality of display elements, and the processor may be configured to modify the output of the plurality of user selectable elements by displaying a reduced number of said plurality of display elements.

The at least one target sound may be a non-verbal sound.

The processor may be coupled to a microphone and the processor may be configured to: receive, via the microphone, an audio signal of audio in the monitored environment; and process the audio signal to recognise the at least one target sound.

The computing device may comprise a communications interface and the processor may be configured to: receive, via said communications interface, a message from a remote computing device in the monitored environment; and recognise the at least one target sound based on receipt of said message.

According to another aspect of the present disclosure, there is provided a computing device for controlling a user interface of the computing device, the computing device comprising a processor configured to: recognise at least one target sound in a monitored environment; determine an operating mode of the computing device that is associated with the at least one target sound; and cause the computing device to control a controllable device in the monitored environment in response to the recognition of the at least one target sound.

According to another aspect of the present disclosure there is provided a method of controlling a display of a computing device, the method comprising: outputting at least one display element on a display of the computing device; whilst the at least one display element is being displayed on the display, recognising at least one target sound in a monitored environment; determining an operating mode of the computing device that is associated with the at least one target sound; and modifying the output of the at least one display element on the display based on the operating mode.

According to another aspect of the present disclosure there is provided a computer-readable storage medium comprising instructions which, when executed by a processor of a computing device cause the computing device to: output at least one display element on a display of the computing device; whilst the at least one display element is being displayed on the display, recognise at least one target sound in a monitored environment; determine an operating mode of the computing device that is associated with the at least one target sound; and modify the output of the at least one display element on the display based on the operating mode.

According to another aspect of the present disclosure there is provided a computing device for controlling a user interface of the computing device, the computing device comprising a processor configured to: recognise at least one target sound in a monitored environment; determine an operating mode of the computing device that is associated with the at least one target sound; output content, via the user interface of the computing device, that is associated with the operating mode, wherein the content prompts a user of the computing device to perform an action using an input device of the computing device to initiate a call to a remote computing device in response to the recognition of the at least one target sound.

The content output by the computing device may prompt a user of the computing device to perform an action using an input device of the computing device to initiate a call to an emergency services telephone number in response to the recognition of the at least one target sound.

The content output by the computing device may prompt a user of the computing device to perform an action using an input device of the computing device to initiate a call to a telephone number of a contact stored in a contact list on the computing device in response to the recognition of the at least one target sound.

According to another aspect of the present disclosure there is provided a computing device comprising a processor configured to: recognise at least one target sound in a monitored environment; determine an operating mode of the computing device that is associated with the at least one target sound; and launch an application installed on the computing device, wherein the application is associated with the operating mode.

It will be appreciated that the functionality of the devices we describe may be divided across several modules. Alternatively, the functionality may be provided in a single module or a processor. The or each processor may be implemented in any known suitable hardware such as a microprocessor, a Digital Signal Processing (DSP) chip, an Application Specific Integrated Circuit (ASIC), Field Programmable Gate Arrays (FPGAs), etc. The or each processor may include one or more processing cores with each core configured to perform independently. The or each processor may have connectivity to a bus to execute instructions and process information stored in, for example, a memory.

The invention further provides processor control code to implement the above-described systems and methods, for example on a general purpose computer system or on a digital signal processor (DSP). The invention also provides a carrier carrying processor control code to, when running, implement any of the above methods, in particular on a non-transitory data carrier—such as a disk, microprocessor, CD- or DVD-ROM, programmed memory such as read-only memory (Firmware), or on a data carrier such as an optical or electrical signal carrier. The code may be provided on a carrier such as a disk, a microprocessor, CD- or DVD-ROM, programmed memory such as non-volatile memory (e.g. Flash) or read-only memory (Firmware). Code (and/or data) to implement embodiments of the invention may comprise source, object or executable code in a conventional programming language (interpreted or compiled) such as C, or assembly code, code for setting up or controlling an ASIC (Application Specific Integrated Circuit) or FPGA (Field Programmable Gate Array), or code for a hardware description language such as Verilog™ or VHDL (Very high speed integrated circuit Hardware Description Language). As the skilled person will appreciate such code and/or data may be distributed between a plurality of coupled components in communication with one another. The invention may comprise a controller which includes a microprocessor, working memory and program memory coupled to one or more of the components of the system.

These and other aspects will be apparent from the embodiments described in the following. The scope of the present disclosure is not intended to be limited by this summary nor to implementations that necessarily solve any or all of the disadvantages noted.

### BRIEF DESCRIPTION OF THE DRAWINGS

For a better understanding of the present disclosure and to show how embodiments may be put into effect, reference is made to the accompanying drawings in which:

FIG. 1 shows a block diagram of example devices in a monitored environment;

FIG. 2 shows a block diagram of a computing device;

FIG. 3 is a flow chart illustrating a process to control a user interface of the computing device according to a first embodiment;

FIG. 4a illustrates the computing device outputting content in the form of an audio message to a user of the computing device

FIG. 4b illustrates the computing device outputting content on a display of the computing device.

FIG. 5 is a flow chart illustrating a process to control a user interface of the computing device according to a second embodiment; and

FIGS. 6a and 6b illustrates an example of how the computing device modifies a display element displayed on the display of the computing device.

### DETAILED DESCRIPTION

Embodiments will now be described by way of example only.

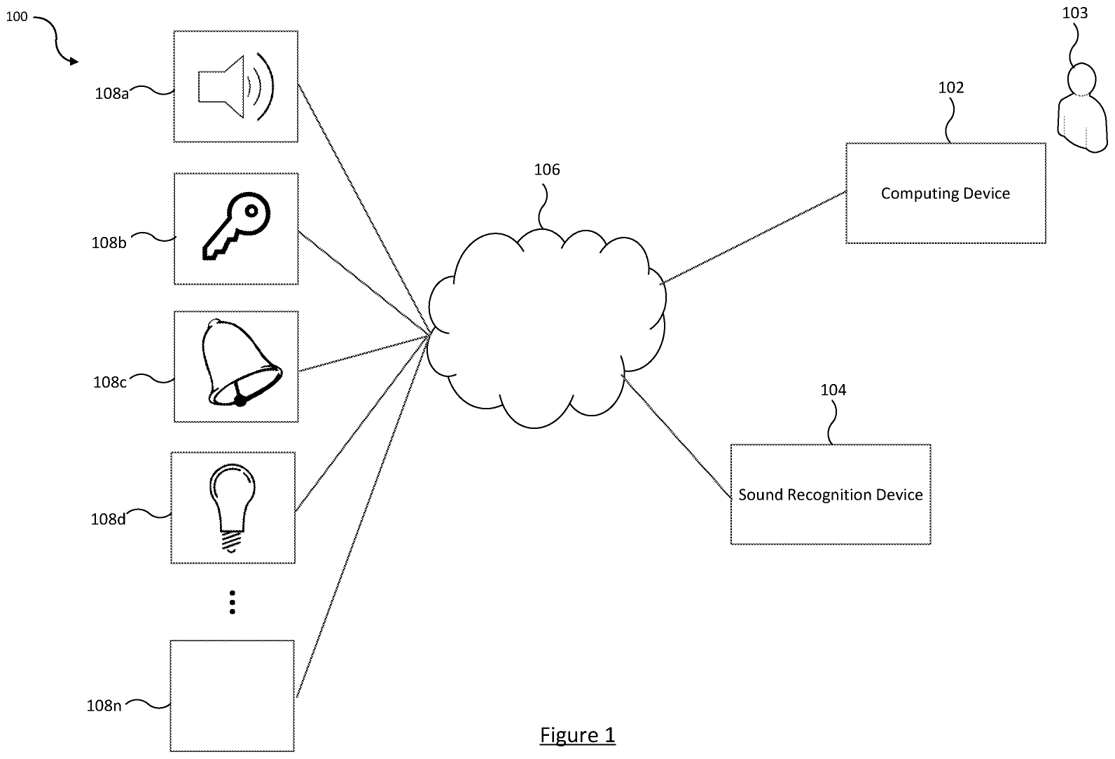

FIG. 1 shows a computing device 102 in a monitored environment 100 which may be an indoor space (e.g. a house, a gym, a shop, a railway station etc.), an outdoor space or in a vehicle. The computing device 102 is associated with a user 103.

In some embodiments of the present disclosure the computing device 102 is coupled via a network 106 to one or more controllable devices 108. The one or more controllable devices 108 may include for example a speaker 108a in the monitored environment 100, a smart door lock 108b of a door in the monitored environment, a remote alarm device 108c in the monitored environment that is operable to output an audible alarm, and a lighting unit 108d in the monitored environment. It will be appreciated that the above are merely examples of controllable devices and embodiments extend to prompting the user 103 of the computing device 102 to perform an action using an input device of the computing device to instruct the computing device to control alternative types of controllable devices than those described above. The term “controllable device” is used herein to refer to any device which is able to receive commands from and be controllable by the computing device 102. In some embodiments, a controllable device does not perform any sound recognition and/or speech recognition.

The network 106 may be a wireless network, a wired network or may comprise a combination of wired and wireless connections between the devices.

As described in more detail below, the computing device 102 may perform audio processing to recognise, i.e. detect, a target sound in the monitored environment 100. In alternative embodiments, a sound recognition device 104 that is external to the computing device 102 may perform the audio processing to recognise a target sound in the monitored environment 100 and then alert the computing device 102 that a target sound has been detected.

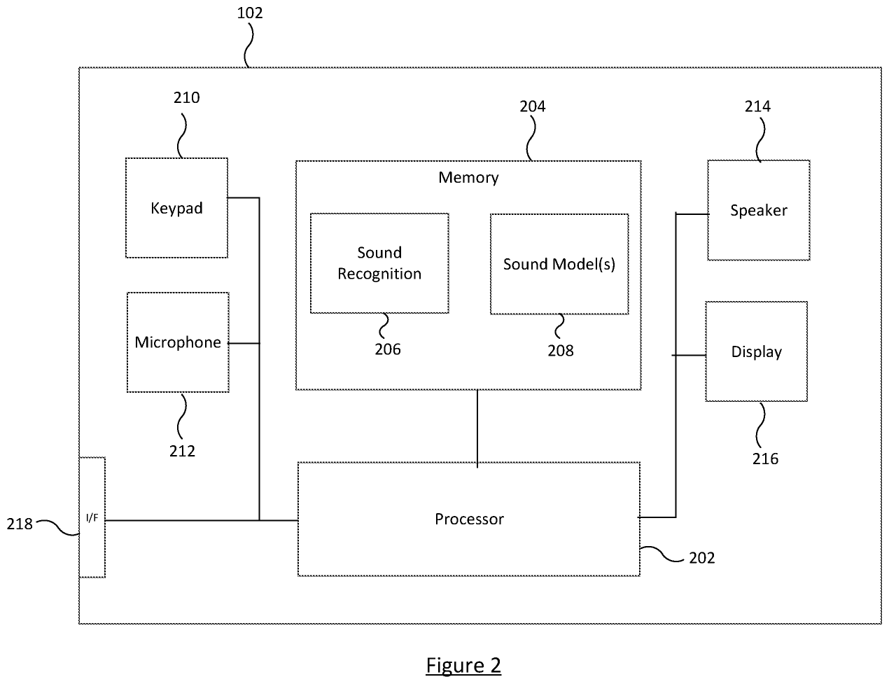

FIG. 2 shows a block diagram of the computing device 102. It will be appreciated from the below that FIG. 2 is merely illustrative and the computing device 102 of embodiments of the present disclosure may not comprise all of the components shown in FIG. 2.

The computing device 102 may be a PC, a mobile computing device such as a laptop, smartphone, tablet-PC, a consumer electronics device (e.g. a smart speaker, TV, headphones, wearable device etc.), or other electronics device (e.g. an in-vehicle device). The computing device 102 may be a mobile device such that the user 103 can move the computing device 102 around the monitored environment. Alternatively, the computing device 102 may be fixed at a location in the monitored environment (e.g. a panel mounted to a wall of a home). Alternatively, the device may be worn by the user by attachment to or sitting on a body part or by attachment to a piece of garment.

The computing device 102 comprises a processor 202 coupled to memory 204 storing computer program code of sound recognition software 206 which is used to recognise a target sound, by comparing detected sounds to one or more sound models 208 stored in the memory 204. The sound model(s) may be associated with one or more target sounds (which may be for example, a breaking glass sound, a smoke alarm sound, a baby cry sound, a sound indicative of the computing device being in a vehicle, a sound indicative of the computing device being outdoors, etc.).

The computing device 102 may comprise one or more input device e.g. physical buttons (including single button, keypad or keyboard) or physical control (including rotary knob or dial, scroll wheel or touch strip) 210 and/or microphone 212. The computing device 102 may comprise one or more output device e.g. speaker 214 and/or display 216. It will be appreciated that the display 216 may be a touch sensitive display and thus act as an input device.

The computing device 102 may also comprise a communications interface 218 for communicating with the one or more controllable devices 108 and/or the sound recognition device. The communications interface 218 may comprise a wired interface and/or a wireless interface.

As shown in FIG. 2, the computing device 102 may store the sound models locally (in memory 204) and so does not need to be in constant communication with any remote system in order to identify a captured sound. Alternatively, the storage of the sound model(s) 208 is on a remote server (not shown in FIG. 2) coupled to the computing device 102, and sound recognition software 206 on the remote server is used to perform the processing of audio received from the computing device 102 to recognise that a sound captured by the computing device 102 corresponds to a target sound. This advantageously reduces the processing performed on the computing device 102.

Further information on the sound model(s) 208 is provided below.

A sound model associated with a target sound is generated based on processing a captured sound corresponding to the target sound class. Preferably, multiple instances of the same sound are captured more than once in order to improve the reliability of the sound model generated of the captured sound class.

In order to generate a sound model the captured sound class(es) are processed and parameters are generated for the specific captured sound class. The generated sound model comprises these generated parameters and other data which can be used to characterise the captured sound class.

There are a number of ways a sound model associated with a target sound class can be generated. The sound model for a captured sound may be generated using machine learning techniques or predictive modelling techniques such as: hidden Markov model, neural networks, support vector machine (SVM), decision tree learning, etc.

The applicant's PCT application WO2010/070314, which is incorporated by reference in its entirety, describes in detail various methods to identify sounds. Broadly speaking an input sample sound is processed by decomposition into frequency bands, and optionally de-correlated, for example, using PCA/ICA, and then this data is compared to one or more Markov models to generate log likelihood ratio (LLR) data for the input sound to be identified. A (hard) confidence threshold may then be employed to determine whether or not a sound has been identified; if a “fit” is detected to two or more stored Markov models then preferably the system picks the most probable. A sound is “fitted” to a model by effectively comparing the sound to be identified with expected frequency domain data predicted by the Markov model. False positives are reduced by correcting/updating means and variances in the model based on interference (which includes background) noise.

It will be appreciated that other techniques than those described herein may be employed to create a sound model.

The sound recognition system may work with compressed audio or uncompressed audio. For example, the time-frequency matrix for a 44.1 KHz signal might be a 1024 point FFT with a 512 overlap. This is approximately a 20 milliseconds window with 10 millisecond overlap. The resulting 512 frequency bins are then grouped into sub bands, or example quarter-octave ranging between 62.5 to 8000 Hz giving 30 sub-bands.

A lookup table can be used to map from the compressed or uncompressed frequency bands to the new sub-band representation bands. For the sample rate and STFT size example given the array might comprise of a (Bin size÷2)×6 array for each sampling-rate/bin number pair supported. The rows correspond to the bin number (centre)—STFT size or number of frequency coefficients. The first two columns determine the lower and upper quarter octave bin index numbers. The following four columns determine the proportion of the bins magnitude that should be placed in the corresponding quarter octave bin starting from the lower quarter octave defined in the first column to the upper quarter octave bin defined in the second column. e.g. if the bin overlaps two quarter octave ranges the 3 and 4 columns will have proportional values that sum to 1 and the 5 and 6 columns will have zeros. If a bin overlaps more than one sub-band more columns will have proportional magnitude values. This example models the critical bands in the human auditory system. This reduced time/frequency representation is then processed by the normalisation method outlined. This process is repeated for all frames incrementally moving the frame position by a hop size of 10 ms. The overlapping window (hop size not equal to window size) improves the time-resolution of the system. This is taken as an adequate representation of the frequencies of the signal which can be used to summarise the perceptual characteristics of the sound. The normalisation stage then takes each frame in the sub-band decomposition and divides by the square root of the average power in each sub-band. The average is calculated as the total power in all frequency bands divided by the number of frequency bands. This normalised time frequency matrix is the passed to the next section of the system where a sound recognition model and its parameters can be generated to fully characterise the sound's frequency distribution and temporal trends.

The next stage of the sound characterisation requires further definitions.

A machine learning model is used to define and obtain the trainable parameters needed to recognise sounds. Such a model is defined by:

a set of trainable parameters θ, for example, but not limited to, means, variances and transitions for a hidden Markov model (HMM), support vectors for a support vector machine (SVM), weights, biases and activation functions for a deep neural network (DNN),

a data set with audio observations o and associated sound labels l, for example a set of audio recordings which capture a set of target sounds of interest for recognition such as, e.g., baby cries, dog barks or smoke alarms, as well as other background sounds which are not the target sounds to be recognised and which may be adversely recognised as the target sounds. This data set of audio observations is associated with a set of labels I which indicate the locations of the target sounds of interest, for example the times and durations where the baby cry sounds are happening amongst the audio observations o.

Generating the model parameters is a matter of defining and minimising a loss function [symbol] (θ|o,l) across the set of audio observations, where the minimisation is performed by means of a training method, for example, but not limited to, the Baum-Welsh algorithm for HMMs, soft margin minimisation for SVMs or stochastic gradient descent for DNNs.

To classify new sounds, an inference algorithm uses the model to determine a probability or a score P(C|o,θ) that new incoming audio observations o are affiliated with one or several sound classes C according to the model and its parameters θ. Then the probabilities or scores are transformed into discrete sound class symbols by a decision method such as, for example but not limited to, thresholding or dynamic programming.

The models will operate in many different acoustic conditions and as it is practically restrictive to present examples that are representative of all the acoustic conditions the system will come in contact with, internal adjustment of the models will be performed to enable the system to operate in all these different acoustic conditions. Many different methods can be used for this update. For example, the method may comprise taking an average value for the sub-bands, e.g. the quarter octave frequency values for the last T number of seconds. These averages are added to the model values to update the internal model of the sound in that acoustic environment.

In embodiments whereby the computing device 102 performs audio processing to recognise a target sound in the monitored environment 100, this audio processing comprises the microphone 212 of the computing device 102 capturing a sound, and the sound recognition 206 analysing this captured sound. In particular, the sound recognition 206 compares the captured sound to the one or more sound models 208 stored in memory 204. If the captured sound matches with the stored sound models, then the sound is identified as the target sound.

### I. Output of Content

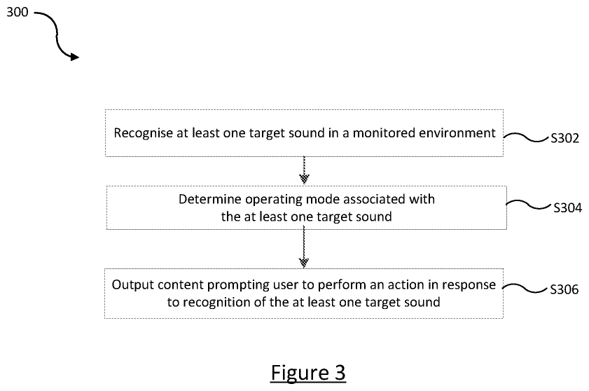

FIG. 3 is a flow chart illustrating a process 300 to control a user interface of the computing device according to a first embodiment. The steps of the process 300 are performed by the processor 202.

At step S302, the processor 202 recognises a target sound in the monitored environment 100.

The microphone 212 of the computing device 102 is arranged to capture a sound in the monitored environment 100. Step S302 may be performed by the processor converting the captured sound pressure waves into digital audio samples and executing the sound recognition software 206 to analyse the digital audio samples (the digital audio samples may be compressed by the processor prior to this analysis being performed). In particular, the sound recognition software 206 compares the captured sound to the one or more sound models 208 stored in memory 204. If the captured sound matches with the stored sound models, then the captured sound is identified as the target sound. Alternatively, the processor 202 may transmit the captured sound via communications interface 218 to a remote server for processing to recognise whether the sound captured by the computing device 102 corresponds to a target sound. That is, the processor 202 may recognise a target sound in the monitored environment 100 based on receiving a message from the remote server that the sound captured by the computing device 102 corresponds to a target sound.

Alternatively, the microphone of the sound recognition device 104 may be arranged to capture a sound in the monitored environment 100 and process the captured sound to recognise whether the sound captured by the sound recognition device 104 corresponds to a target sound. In this example, the sound recognition device 104 is configured to transmit a message via the network 106 to the computing device 102 to alert the computing device 102 that a target sound has been detected. That is, the processor 202 may recognise a target sound in the monitored environment 100 based on receiving a message from the sound recognition device 104.

Regardless of where the processing of the captured sound is performed, the recognition of a target sound comprises recognising a non-verbal sound (i.e. a non-speech sound event). The non-verbal sound may be any non-speech sound that may be generated in the environment of the sound capture device (the computing device 102 or the sound recognition device 104), for example a breaking glass sound, smoke alarm sound, baby cry sound etc. The non-verbal sound may be a sound produced by a human (e.g. paralinguistic speech such as laughter or coughing) or an animal. The non-verbal sound may be a vocal sound such as onomatopoeia (for example the imitation of animal sounds). This is in contrast to known voice assistant devices that typically respond to the detection of a human speaking a command word.

At step S304, the processor 202 determines an operating mode of the computing device 102 that is associated with the target sound.

At step S306, the processor 202 outputs content, via a user interface of the computing device, that is associated with the operating mode. The content that is output by the processor 202 prompts the user 103 of the computing device 102 to perform an action using an input device of the computing device 102 in response to the recognition of the target sound.

Controllable Device Mode

The operating mode may be associated with controlling a controllable device 108 in the monitored environment 100. That is, the content outputted by the processor 202 prompts the user to perform an action using an input device of the computing device 102 to instruct the computing device to control a controllable device 108 in the monitored environment 100.

At step S306, the computing device 102 may output content that prompts a user of the computing device to perform an action using an input device of the computing device to instruct the computing device to control the remote alarm device 108c in the monitored environment to output an audible alarm. For example, if the computing device 102 recognises a breaking glass sound (an example target sound) or a smoke alarm sound (an example target sound). This example content may be output when a target sound other than a smoke alarm sound is recognised.

At step S306, the computing device 102 may output content that prompts a user of the computing device to perform an action using an input device of the computing device to instruct the computing device to control the speaker 108a to play audio (e.g. a lullaby in an attempt to calm a baby). For example if the computing device 102 recognises a baby cry sound (an example target sound). This example content may be output when a target sound other than a baby cry sound is recognised. In response to the recognition of a baby cry sound the computing device 102 may also output an option for the user to view or listen to audio from the baby's room if the computing device 102 is coupled to a baby monitor in the baby's room.

At step S306, the computing device 102 may output content that prompts a user of the computing device to perform an action using an input device of the computing device to instruct the computing device to control the lighting unit 108d. For example if the computing device 102 recognises a baby cry sound (an example target sound), the user 103 may be prompted to turn on a lighting unit located between the parent's room and the baby's room to assist the parent with walking to the baby's room, or to control the colour, brightness, sequence of light emitted by the lighting unit located in the baby's room. In another example, if the computing device 102 recognises a smoke alarm sound (an example target sound) the user 103 may be prompted to turn on all connected lights in a home. This example content may be output when a target sound other than a baby cry sound or a smoke alarm sound is recognised.

At step S306, the computing device 102 may output content that prompts a user of the computing device to perform an action using an input device of the computing device to instruct the computing device to control a smart door lock 108b to open. For example, if the computing device 102 recognises a smoke alarm sound (an example target sound) the user 103 may be prompted to unlock the smart door lock(s) 108b for the safety of persons in a home. This example content may be output when a target sound other than a smoke alarm sound is recognised.

It will be appreciated that at step S306, the processor 202 may output content, via a user interface of the computing device, that prompts the user 103 of the computing device 102 to perform an action using an input device of the computing device 102 to instruct the computing device to control other controllable devices 108 not referred to herein in response to the recognition of the target sound.

It will be appreciated that the target sounds referred to above (breaking glass sound, smoke alarm sound, baby cry sound etc.) are merely examples. Other examples include a dog bark, anomaly detection, snore, car alarm, cough, laugh, car horn, emergency vehicle siren, doorbell, bicycle bell, vehicle-reversing alert, yawn, shout, door knock, intruder alarm and sneeze. Embodiments extend to other target sounds to those referred to herein.

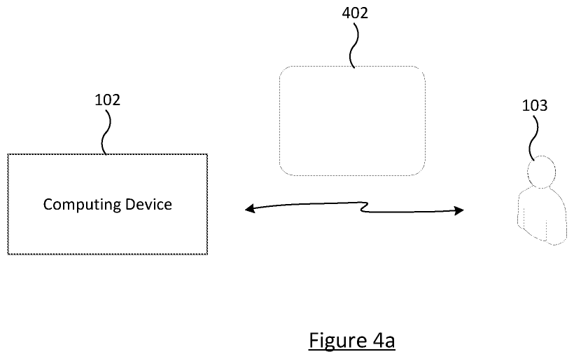

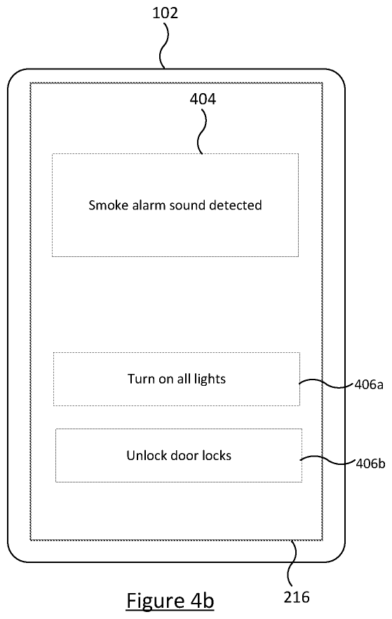

At step S306, the computing device 102 may output the content via speaker 214 in the form of an audio message to the user 103, for example in embodiments whereby the computing device 102 is a voice assistant device (smart speaker). FIG. 4a illustrates the computing device 102 outputting an audio message 402 to the user 103, whereby the audio message 402 prompts the user 103 of the computing device 102 to perform an action using an input device of the computing device 102 to instruct the computing device 102 to control a controllable device 108 e.g. “smoke detected, shall I sound the alarm?”.

The computing device 102 is arranged to process a response by the user 103. For example, in the case of the computing device 102 being a voice assistant device, the processor 202 is configured to receive speech via the microphone 212, perform speech recognition using a speech recognition module not shown in FIG. 2), and control an appropriate controllable device in response to processing the received speech.

Alternatively, the computing device 102 may output the content via display 216 in the form of at least one user selectable element each associated with controlling a controllable device. FIG. 4b illustrates the computing device 102 that has output a first user selectable element 406a which prompts the user 103 of the computing device 102 to perform an action using an input device of the computing device 102 to instruct the computing device 102 to control a controllable device 108 (the lighting unit 108d in this example), and a second user selectable element 406a which prompts the user 103 of the computing device 102 to perform an action using an input device of the computing device 102 to instruct the computing device 102 to control a further controllable device 108 (the door lock 108b in this example). The content may also comprise text 404 indicating what target sound has been recognised.

Whilst FIG. 4b illustrates the user selectable elements as buttons this is merely an example and a user selectable element can take an alternative form (e.g. a slider).

The computing device 102 is arranged to process a response by the user 103. That is, the processor 202 is configured to detect selection, by the user 103, of a displayed user selectable element and control the controllable device 108 associated with the selected user selectable element.

Call Mode

Alternatively or additionally, the operating mode may be associated with a call mode.

In this implementation, at step S306 the processor 202 is configured to output content, via the user interface of the computing device, wherein the content prompts the user of the computing device to perform an action using an input device of the computing device to initiate a call to a remote computing device.

For example, if the computing device 102 recognises a smoke alarm sound (an example target sound) or a breaking glass sound (an example target sound) the processor 202 may prompt the user 103 to initiate a call to an emergency services telephone number in response to the recognition of the target sound. This example content may be output when target sounds other than a smoke alarm sound or a breaking glass sound are recognised (e.g. a gunshot or other examples).

In another example, the processor 202 may output content, via the user interface of the computing device, wherein the content prompts the user of the computing device to perform an action using an input device of the computing device to initiate a call to a telephone number of a contact stored in a contact list on the computing device in response to the recognition of the target sound.

The target sound may be for example a sound associated with an elderly relative feeling lonely (adult cry, sobbing, sniff, sigh, tutting, particular activity patterns, absence of movement) and in response to recognising the target sound the processor 202 may output content prompting the user to initiate a call to a relative or a carer.

The target sound may be for example a sound that might be scary to a child when alone (shout, tyre squeal, gunshot, emergency vehicle siren, police siren, car horn, helicopter) and in response to recognising the target sound the processor 202 may output content prompting the user to initiate a call to a parent or carer.

The target sound may be for example a sound indicative of a right moment to reconnect with a family member (e.g. a sound of singing, child laugh, music) and in response to recognising the target sound the processor 202 may output content prompting the user to initiate a call to a family member.

Application Mode

In another implementation, the operating mode may be associated with launching an application. That is, at step S306 the processor 202 is configured to launch an application installed on the computing device, wherein the application is associated with the operating mode, to thereby output content associated with the application.

The target sound may be for example a sound indicative of “start of the day” (e.g. an alarm clock, footsteps, crockery, cutlery, cupboard open/close, hairdryer, electric shaver, kettle boiling) and in response to recognising the target sound the processor 202 may launch the calendar application or some business assistant application installed on the device to thereby output content associated with the application.

The target sound may be for example a sound indicative of “moment appropriate for or requiring me time” (e.g. keyboard typing, car alarm, child crying, hairdryer, vacuum cleaner, footsteps, silence) and in response to recognising the target sound the processor 202 may launch a music playback application or relaxation application to thereby output content associated with the application.

The target sound may be for example a sound indicative of “moment appropriate for relaxing bathroom experience” (e.g. door open/close, sigh, hair dryer, bath filling/washing, silence, music) and in response to recognising the target sound the processor 202 may launch a music playback to thereby output content associated with the application.

### II. Modification of Content

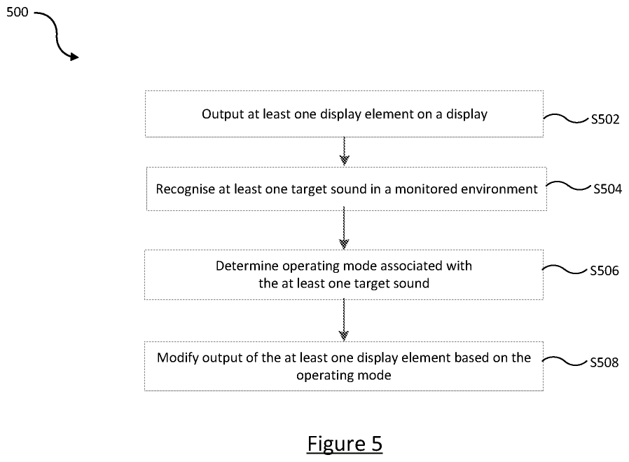

FIG. 5 is a flow chart illustrating a process 500 to control a user interface of the computing device according to a second embodiment. The steps of the process 500 are performed by the processor 202.

In contrast to process 300, which relates to the computing device 102 outputting “new” content to a user in response to recognising a target sound (that is, the content was not output prior to the target sound being recognised) process 500 relates to the computer device modifying the output of content output by the computing device 102 in response to the recognition of a target sound.

At step S502, the processor 202 outputs at least one display element on the display 216 of the computer device 102.

The display element may for example be an element of a webpage displayed by a web browser running on the processor 202, an element of user interface of an application running on the processor 202, or an element of a homepage displayed by an operating system running on the processor 202.

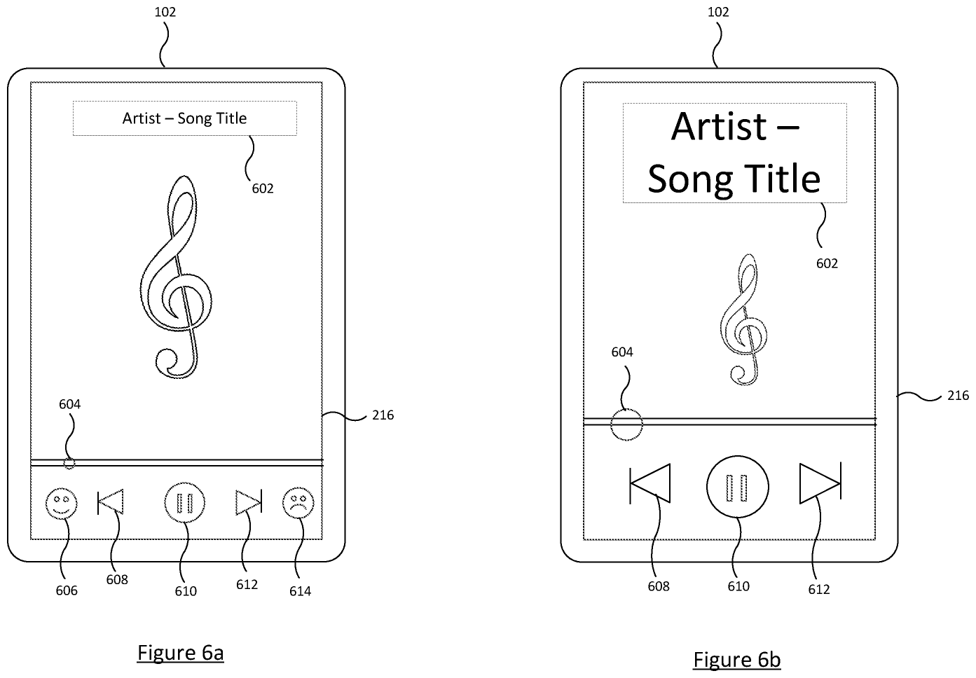

As a mere illustration to assist explanation of the concepts, FIG. 6a shows computing device 102 displaying a user interface of a music playback application before a target sound has been recognised.

The user interface of the music playback application comprises a plurality of display elements which include text 602 (for example relating to the artist and song title of the song being output to the user 103) and a plurality of user selectable elements 606-614. In the example of FIG. 6a the plurality of user selectable elements comprise a slider actuator button 604 which allows a user to skip playback of a song forward/back, a like button 606, a previous track selection button 608, a pause button 610, a next track selection button 612 and a dislike button 614.

At step S504, whilst the at least one display element is being displayed on the display 216 of the computer device 102, the processor 202 recognises a target sound in the monitored environment 100.

The microphone 212 of the computing device 102 is arranged to capture a sound in the monitored environment 100. Step S504 may be performed by the processor converting the captured sound pressure waves into digital audio samples and executing the sound recognition software 206 to analyse the digital audio samples (the digital audio samples may be compressed by the processor prior to this analysis being performed). In particular, the sound recognition software 206 compares the captured sound to the one or more sound models 208 stored in memory 204. If the captured sound matches with the stored sound models, then the captured sound is identified as the target sound. Alternatively, the processor 202 may transmit the captured sound via communications interface 218 to a remote server for processing to recognise whether the sound captured by the computing device 102 corresponds to a target sound. That is, the processor 202 may recognise a target sound in the monitored environment 100 based on receiving a message from the remote server that the sound captured by the computing device 102 corresponds to a target sound.

Alternatively, the microphone of the sound recognition device 104 may be arranged to capture a sound in the monitored environment 100 and process the captured sound to recognise whether the sound captured by the sound recognition device 104 corresponds to a target sound. In this example, the sound recognition device 104 is configured to transmit a message via the network 106 to the computing device 102 to alert the computing device 102 that a target sound has been recognised. That is, the processor 202 may recognise a target sound in the monitored environment 100 based on receiving a message from the sound recognition device 104.

Regardless of where the processing of the captured sound is performed, the recognition of a target sound comprises recognising a non-verbal sound (i.e. a non-speech sound event). The non-verbal sound may be any sound that may be generated in the environment of the sound capture device (the computing device 102 or the sound recognition device 104) for example breaking glass sound, smoke alarm sound, baby cry sound etc. The non-verbal sound may be a sound produced by a human (e.g. paralinguistic speech such as laughter or coughing) or animal. The non-verbal sound may be a vocal sound such as onomatopoeia (for example the imitation of animal sounds).

At step S506, the processor 202 determines an operating mode of the computing device 102 that is associated with the target sound.

At step S508, the processor 202 modifies the output of the at least one display element based on the operating mode.

It will be appreciated that the modification performed at step S508 is dependent on the operating mode of the computing device. FIG. 6b shows computing device 102 displaying a user interface of a music playback application after a target sound has been recognised

In one example, the modification performed at step S508 comprises modifying the output of the text by modifying a font size of the text 602 (for example increasing the font size of the text 602) as shown in FIG. 6b.

In another example, the modification performed at step S508 comprises modifying the output of a user selectable element by modifying a size of the user selectable element (for example increasing the size of the user selectable element). This is shown in FIG. 6b whereby the slider actuator button 604, the previous track selection button 608, the pause button 610, and the next track selection button 612 have increased in size.

In another example where the processor 202 displays a plurality of display elements prior to the target sound being recognised, the modification performed at step S508 comprises modifying the output of the plurality of display elements by displaying a reduced number of the plurality of display elements. This is shown in FIG. 6b whereby the like button 606 and dislike button 614 are not displayed by the processor 202 after the target sound has been recognised.

In another example, the modification performed at step S508 comprises replacing a display element (displayed prior to the target sound being recognised) with a new display element (that was not displayed prior to the target sound being recognised).

The target sound may be for example a sound indicative that a user is in a vehicle with their computing device 102 (e.g., seatbelt click, seatbelt pull, vehicle door close, keys, engine start, indicator clicking etc.). By automatically detecting that the user 103 is in a vehicle, simplified controls are provided to the user 103 to enable them to more easily interact with the user interface being displayed by their computing device (e.g. to more easily control a music application or navigation application). This avoids the processor 202 having to process multiple button presses when a user 103 makes incorrect or unintentional selections in the user interface displayed on the display of the computing device 102 due to operating the device whilst driving. The process 500 also provides safety benefits for the user as it minimises the time spent by the user interacting with the user interface displayed on the display of the computing device 102 as incorrect selections are avoided. In another example, the target sound may be for example a sound indicative that a user is having a walk outdoors (e.g. bird chirp, tree rustle, car horn, plane flying over, lawnmower etc.). By automatically detecting that the user 103 is having a walk outdoors, simplified controls are provided to the user 103 to enable them to more easily interact with the user interface being displayed by their computing device (e.g. to read the text displayed on a webpage). This avoids the processor 202 having to process multiple button presses when a user 103 makes incorrect or unintentional selections in the user interface displayed on the display of the computing device 102 due to walking outdoors.

Thus, it can be seen that embodiments described herein use sound recognition to improve a user's experience of a computing device by adapting to the environment of the user.

1. A computing device for controlling a user interface of the computing device, the computing device comprising a processor configured to:
recognise at least one target sound in a monitored environment;
determine an operating mode of the computing device that is associated with the at least one target sound; and
output content, via the user interface of the computing device, that is associated with the operating mode, wherein the content prompts a user of the computing device to perform an action using an input device of the computing device to instruct the computing device to control a controllable device in the monitored environment in response to the recognition of the at least one target sound.

2. The computing device of claim 1, wherein the user interface is a speaker coupled to said processor and the input device is a microphone of the computing device, and the content is an audio message

3. The computing device of claim 2, wherein the processor is configured to:
receive via the microphone an instruction from the user to control the controllable device; and
control the controllable device in response to receiving said instruction.

4. The computing device of claim 1, wherein the user interface is a display coupled to said processor and the content comprises at least one user selectable element.

5. The computing device of claim 4, wherein the processor is configured to:
detect selection of the at least one user selectable element; and
control the controllable device in response to said selection.

6. The computing device of claim 1, wherein the at least one target sound is a non-verbal sound.

7. The computing device of claim 1, wherein the at least one target sound is one of a breaking glass sound, a smoke alarm sound, and a baby cry sound.

8. The computing device of claim 1, wherein the content prompts a user of the computing device to perform an action using an input device of the computing device to instruct the computing device to control a remote alarm device in the monitored environment to output an audible alarm.

9. The computing device of claim 1, wherein the content prompts a user of the computing device to perform an action using an input device of the computing device to instruct the computing device to control a lighting unit in the monitored environment.

10. The computing device of claim 1, wherein the content prompts a user of the computing device to perform an action using an input device of the computing device to instruct the computing device to control a door lock of a door in the monitored environment.

11. The computing device of claim 1, wherein the content prompts a user of the computing device to perform an action using an input device of the computing device to instruct the computing device to control a speaker in the monitored environment to play audio.

12. The computing device of claim 1, wherein the processor is coupled to a microphone and the processor is configured to:
receive, via the microphone, an audio signal of audio in the monitored environment; and
process the audio signal to recognise the at least one target sound.

13. The computing device of claim 1, wherein the computing device comprises a communications interface and the processor is configured to:
receive, via said communications interface, a message from a remote computing device in the monitored environment; and
recognise the at least one target sound based on receipt of said message.

14. The computing device of claim 1, wherein the content additionally prompts a user of the computing device to perform an action using an input device of the computing device to initiate a call to a remote computing device in response to the recognition of the at least one target sound.

15. The computing device of claim 1, wherein the content additionally prompts a user of the computing device to perform an action using an input device of the computing device to initiate a call to a telephone number of a contact stored in a contact list on the computing device in response to the recognition of the at least one target sound.

16. A method of controlling a user interface of a computing device, the method comprising:
recognising at least one target sound in a monitored environment;
determining an operating mode of the computing device that is associated with the at least one target sound;
outputting content, via the user interface of the computing device, that is associated with the operating mode, wherein the content prompts a user of the computing device to perform an action using an input device of the computing device to instruct the computing device to control a controllable device in the monitored environment in response to the recognition of the at least one target sound.

17. The method of claim 16, wherein the at least one target sound is a non-verbal sound.

18. A computer-readable storage medium comprising instructions which, when executed by a processor of a computing device cause the computing device to perform the method of claim 16.

19. A computing device comprising a processor configured to:
recognise at least one target sound in a monitored environment;
determine an operating mode of the computing device that is associated with the at least one target sound; and
launch an application installed on the computing device, wherein the application is associated with the operating mode.

20. A computer implemented method for controlling a computing device comprising:
recognising at least one target sound in a monitored environment;
determining an operating mode of the computing device that is associated with the at least one target sound; and
launching an application installed on the computing device, wherein the application is associated with the operating mode.
